(19) United States
(12) Patent Application Publication
(10) Pub. No.: US 2023/0211956 A1
(43) Pub. Date: Jul. 6, 2023

(54) ADJUSTABLE CURVED TUNNEL CONVEYOR SYSTEM

(71) Applicant: ASGCO Manufacturing, Inc., Nazareth, PA (US)

(72) Inventors: Andrew M. COLLIER, Whitehall, PA (US); Leroy C. WILLIAMS, Hellertown, PA (US); Aaron T. GIBBS, Easton, PA (US)

(21) Appl. No.: 18/089,719

(22) Filed: Dec. 28, 2022

Related U.S. Application Data
(60) Provisional application No. 63/294,881, filed on Dec. 30, 2021.

(51) Int. Cl. B65G 15/60; B65G 39/12

(52) U.S. Cl. CPC B65G 15/60; B65G 39/125

(57) ABSTRACT

Apparatus and method that allows a conveyor belt operator to manually adjust a moving conveyor belt pitch around a curve in a confined space such as a tunnel, while also automatically adjusting skew to restore conveyor belt drift. The apparatus includes a rail pair between which a set of trough rollers, and a lower elevated return roller set, are adjustably mounted. The trough roller set is releasably and adjustably secured to brackets that can slide along a respective rail while the return rollers are also releasably coupled to respective sliding brackets on respective rails. Couplings are used to adjustably secure the trough roller set, and return roller set, to respective brackets by either selecting different bracket elevation attachment points and/or by changing couplings' length. A second set of trough rollers can also be slidably/adjustably mounted on the rails with the return rollers being located between the two trough roller sets.

### CROSS-REFERENCE TO RELATED APPLICATIONS

This non-provisional application claims the benefit under 35 U.S.C. § 119(e) of Application Serial No. 63/294,881 filed on Dec. 30, 2021 entitled ADJUSTABLE CURVED TUNNEL CONVEYOR SYSTEM and whose entire disclosure is incorporated by reference herein.

### BACKGROUND OF THE INVENTION

The present invention relates to conveyor belt systems, and more particularly, to a device that can direct a conveyor belt around a curve in a confined space such as a curved tunnel.

Conveyor belt systems can take on a variety of pathways depending on the payload that they are transporting as well as the environment that the conveyor system is located in, such as linear, curved, inclined, etc.

One particular environment that provides significant challenges for conveyor belt systems is in curved tunnels. In this environment, the conveyor belt system not only needs to convey the payload around turns, it must do so with a particular pitch while avoiding belt or payload contact with the tunnel sidewalls and ceiling since tunnels are typically very confined spaces. As a result, the need to adjust the conveyor belt pitch easily and quickly is important.

As shown in FIG. 1, during a linear conveyor belt run, upper trough rollers TR maintain the conveyor belt CB in a “trough shape” for conveying the material burden or payload (see “MAT”) thereon to the delivery point (not shown) and the conveyor belt CB passes over a pulley head (also not shown) which then “returns” the conveyor belt CB on the return rollers RR. As shown most clearly in FIG. 1, during a linear conveyor belt CB run, the belt CB is thus centered on a center roller CR and the two outside wing rollers WR, as well as on the return rollers RR. When the conveyor belt CB encounters a turn or curve CRVE, as shown in FIG. 1A, the conveyor belt CB tension is skewed in the direction of arrow B, which tends to pull the conveyor belt CB in the direction of arrow C, up along one of the wing rollers WR. If no correction is introduced, the conveyor belt CB will continue to ride up on the wing roller WR, causing spillage of the payload as well as damaging the conveyor belt CB, as shown in FIG. 1B. Moreover, implementing such a correction is further complicated by the fact that many of these curves CRVE in a tunnel are themselves very confined spaces.

Thus, there remains a need for a conveyor belt system that can be easily and quickly adjusted in curved and confined tunnel environments. The present invention addresses such needs.

All references cited herein are incorporated herein by reference in their entireties.

### BRIEF SUMMARY OF THE INVENTION

An apparatus for manually adjusting the pitch of a conveyor belt, both a delivery portion having a payload thereon and a return portion after the payload has been removed, and automatically restoring the drift of a conveyor belt around a turn (or curve) in a confined space (e.g., a tunnel, an underground tunnel, etc.) is disclosed. The apparatus comprises: a pair of rails between which a first set of conveyor belt rollers are slidably coupled and wherein the first set of conveyor belt rollers is positioned at a first end of the pair of rails at a first elevation above the pair or rails for supporting the delivery portion of the conveyor belt; a second set of conveyor belt rollers slideably coupled between the pair of rails and wherein the second set of conveyor belt rollers are positioned below the pair of rails at a lower elevation than the first elevation for supporting the return portion of the conveyor belt; a first pair of brackets that can slide on respective rails and to which respective ends of the first set of conveyor belt rollers can be adjustably coupled thereto; and a second pair of brackets that can slide on respective rails and to which respective ends of the second set of conveyor belt rollers can be adjustably coupled thereto.

A method for manually adjusting the pitch of a conveyor belt, having a delivery portion with a payload thereon and a return portion after the payload has been removed, and automatically restoring the drift of a conveyor belt around a turn (or curve) in a confined space (e.g., a tunnel, an underground tunnel, etc.) is disclosed. The method comprises: providing a pair of rails between which a first set of conveyor belt rollers are slidably coupled and wherein the first set of conveyor belt rollers are positioned at a first end of the pair of rails at a first elevation above the pair of rails for supporting the delivery portion of the conveyor belt; providing a second set of conveyor belt rollers slideably coupled between the pair of rails and wherein the second set of conveyor belt rollers are positioned below the pair of rails at a lower elevation than the first elevation for supporting the return portion of the conveyor belt; adjustably coupling respective ends of the first set of conveyor rollers to a first pair of brackets that can slide on respective rails; adjustably coupling respective ends of the second set of conveyor rollers to a second pair of brackets that can slide on respective rails; and suspending the pair of rails in the confined space at the curve.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a functional diagram of a prior art conveyor belt system showing linear conveyor belt travel and the relative positions of the trough rollers and the return rollers;

FIG. 1A is a functional diagram of the prior art conveyor belt system of FIG. 1 showing the introduction of a curve in the conveyor belt and the resulting motion of the belt on the trough rollers;

FIG. 1B is a functional diagram of the prior art conveyor belt system of FIG. 1, following on from FIG. 1A, showing the resulting undesired transverse motion of the conveyor belt with no correcting pitch and skew of the trough rollers and return rollers;

FIG. 2 is a functional diagram showing how the adjustable curved tunnel conveyor system (ACTCS) of the present invention allows for the correct pitch and skew to maintain the conveyor centered on the trough rollers and return rollers through the tunnel curve;

FIG. 3 is a front view of the adjustable curved tunnel conveyor system (ACTCS) of the present invention mounted in a curved tunnel shown partially;

FIG. 4 is an isometric view of the stringer frame of the ACTCS;

FIG. 4A is an isometric view of the ACTCS including the trough rollers and the return rollers releasably and adjustably coupled to the stringer frame, with the couplings between rollers omitted for clarity;

FIG. 4B is a front view of the stringer frame;

FIG. 4C is a side view of the ACTCS with the rear set of trough rollers omitted;

FIG. 4D is a view taken along line 4D-4D of FIG. 4B showing an inner side of one of the stringer rails of the ACTCS, and showing only one of the adjustable troughing upright brackets thereon;

FIG. 5 shows the outer side of one of the adjustable troughing upright brackets;

FIG. 5A is a side view of one of the adjustable troughing upright brackets;

FIG. 5B is an isometric view of one of the adjustable troughing upright brackets;

FIG. 5C is a view taken along line 5C-5C of FIG. 5A;

FIG. 6 depicts a set of trough rollers for the ACTCS and exemplary couplings and exemplary roller couplings;

FIG. 7 depicts a set of return rollers for the ACTCS and exemplary couplings and exemplary roller couplings;

FIG. 8 depicts an exemplary overall first pitch of the trough rollers and corresponding overall first pitch of the return rollers of the ACTCS in the curved tunnel;

FIG. 9 depicts an exemplary overall second pitch of the trough rollers and corresponding overall second pitch of the return rollers of the ACTCS in the curved tunnel;

FIG. 10 depicts opposing adjustable troughing upright brackets with the coupling (e.g., a chain) being releasably coupled to alternative apertures in the brackets for achieving a particular pitch of the trough rollers in the ACTCS;

FIG. 11 depicts one adjustable troughing upright bracket showing how different lengths of the coupling can also fine tune the pitch adjustment on one outer end of the trough rollers, by way of example only;

FIG. 12 depicts one return roller bracket showing how the different lengths of the coupling are used to alter the pitch of the return rollers on one outer end of the return rollers, by way of example only;

FIGS. 13A-13B are functional diagrams (with the ACTCS adjustable troughing upright brackets, and couplings, and couplings between rollers, being omitted for clarity) that provide a functional view of the trough rollers “steering the conveyor belt” by allowing the trough rollers to pivot or skew;

FIGS. 13C-13D are functional diagrams (again, with the ACTCS adjustable troughing upright brackets, and couplings, and couplings between rollers, being omitted for clarity) showing how the trough rollers pivot by their outer ends moving in opposite directions along respective stringers of the ACTCS stringer frame;

FIG. 14 is a functional diagram (with the ACTCS adjustable return roller brackets, and couplings, and couplings between rollers, being omitted for clarity) showing how the return rollers also pivot by their outer ends moving in opposite directions along respective stringers of the ACTCS stringer frame;

FIG. 15 is an isometric view of a second embodiment of the ACTCS of the present invention which uses only one set of trough conveyor rollers at one end of the stringer frame, and with the couplings between rollers omitted for clarity;

FIG. 15A is an isometric view of a third embodiment of the ACTCS of the present invention which also uses only one set of trough conveyor rollers at the other end of the stringer frame, and with the couplings between rollers omitted for clarity;

FIG. 16 shows an alternative coupling comprising a hook;

FIG. 16A depicts another adjustable troughing upright bracket for use with the alternative hook coupling of FIG. 16;

FIG. 16B depicts another alternative coupling using a threaded element (e.g., rod) and nut combination; and

FIGS. 16C and 16D depict a further adjustable troughing upright bracket for use with the alternative threaded rod coupling of FIG. 16B and showing how different lengths of the threaded rod coupling can also fine tune the pitch adjustment on one outer end of the trough rollers, by way of example only.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

In many of the figures, the conveyor trough support rollers 22 and the return rollers 24 may appear “floating” and/or without the conveyor belt CB depicted thereon, but this is done for clarity only to show the orientation of the various roller sets with respect to the stringer frame 26, all of which are discussed below in detail.

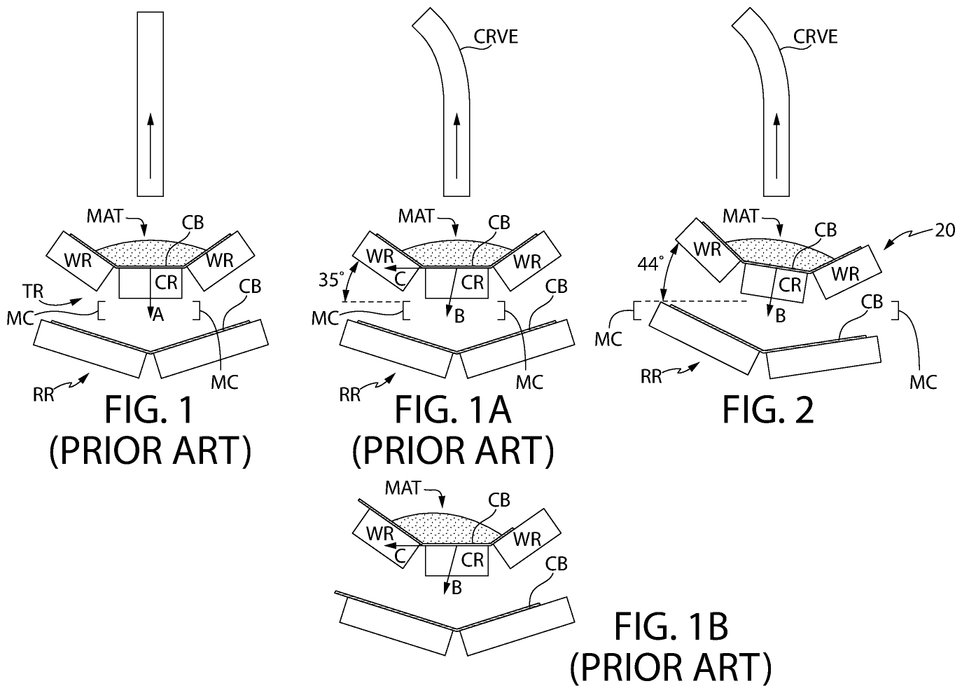

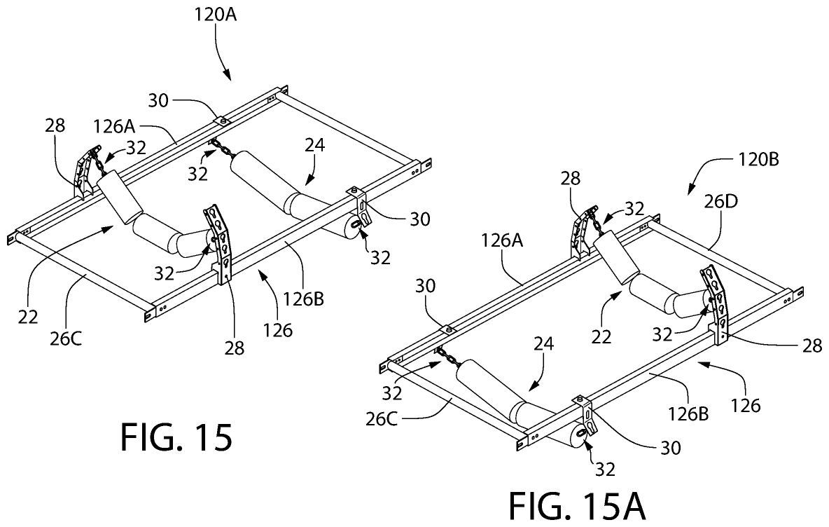

The present invention 20, referred to as an adjustable curved tunnel conveyor system (ACTCS), is used for maintaining a conveyor belt to be centered on the support rollers and return rollers as the conveyor belt moves through a curve CRVE in a tunnel T. This is accomplished by adjusting the pitch of the trough rollers 22 and return rollers 24 to be perpendicular to the direction of belt tension, which mitigates the translation of the conveyor belt CB toward the side of the trough rollers 22, as depicted in FIG. 2. By way of example only, a pitch of 44° is indicated as measured from a horizontal reference, namely, the top edge of a mounting channel bracket MC is shown for comparison with prior art FIGS. 1-1A only; however, as discussed in detail below, the trough rollers 22 are suspended from brackets 28 in a stringer frame 26 using couplings 32 so there are no mounting channel brackets MC associated with the present invention 20 (or 120A (FIG. 15) or 120B (FIG. 15A)).

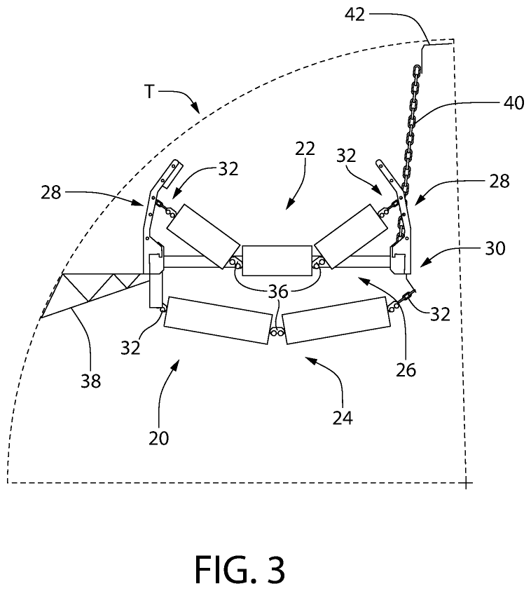

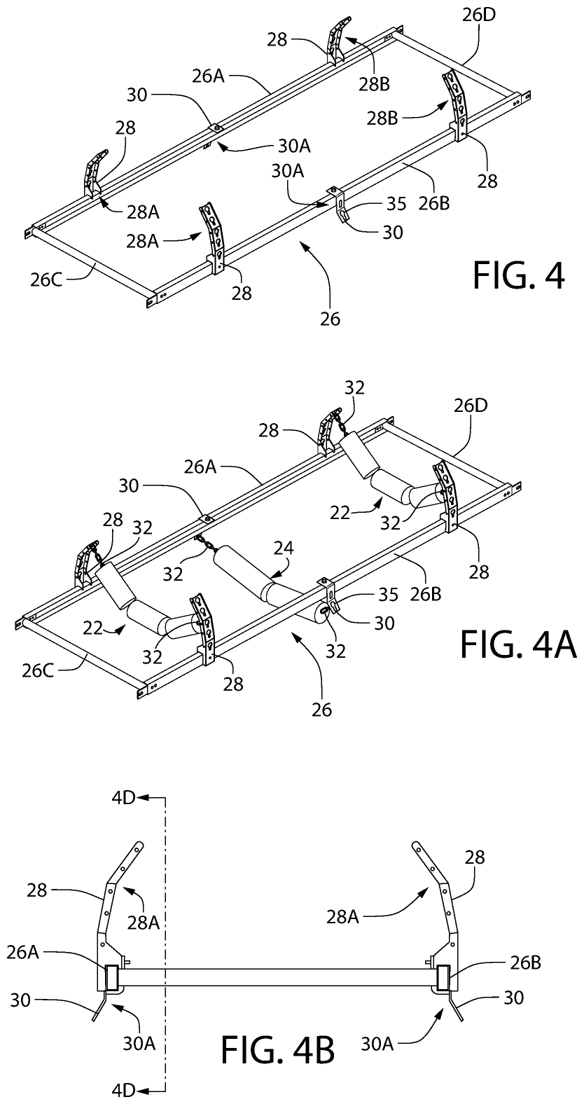

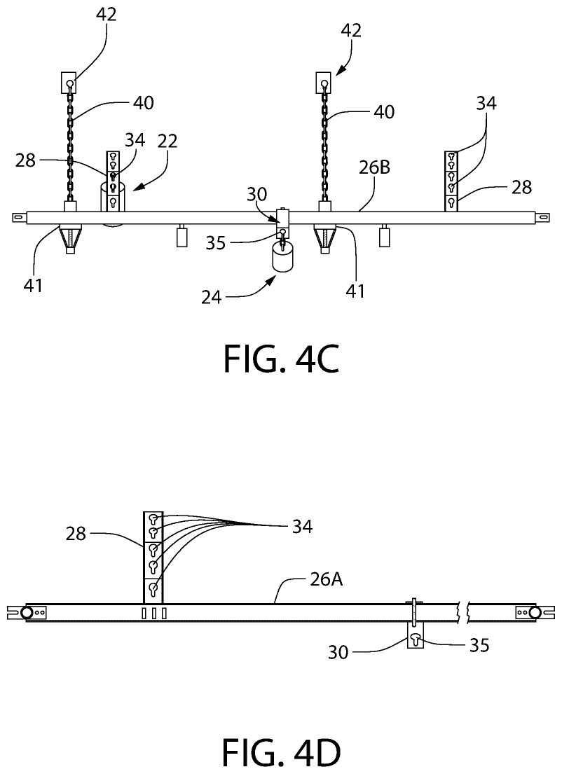

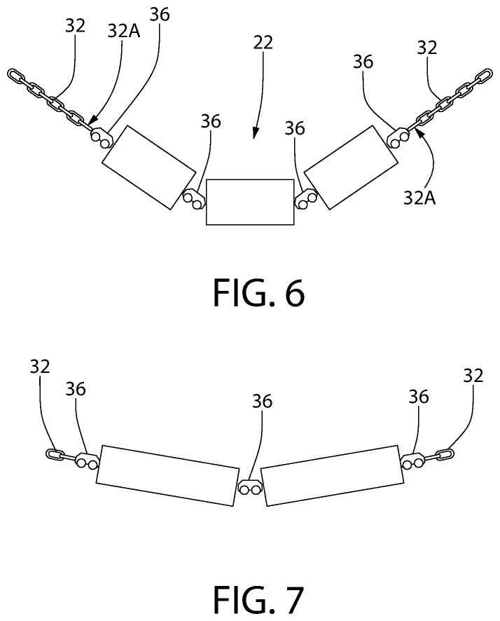

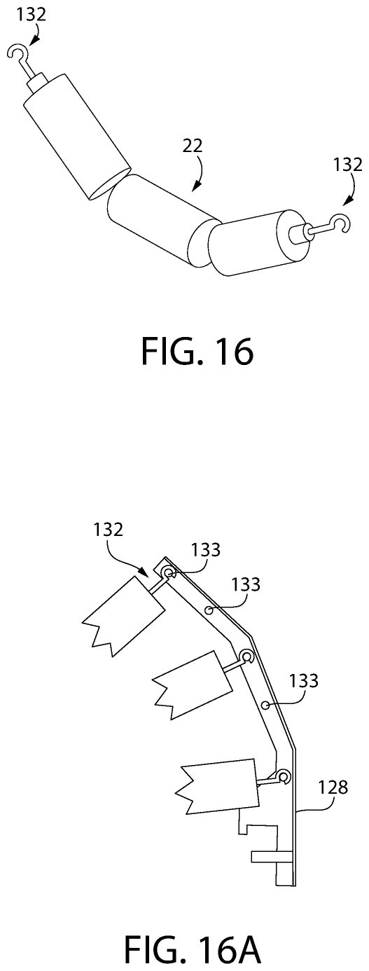

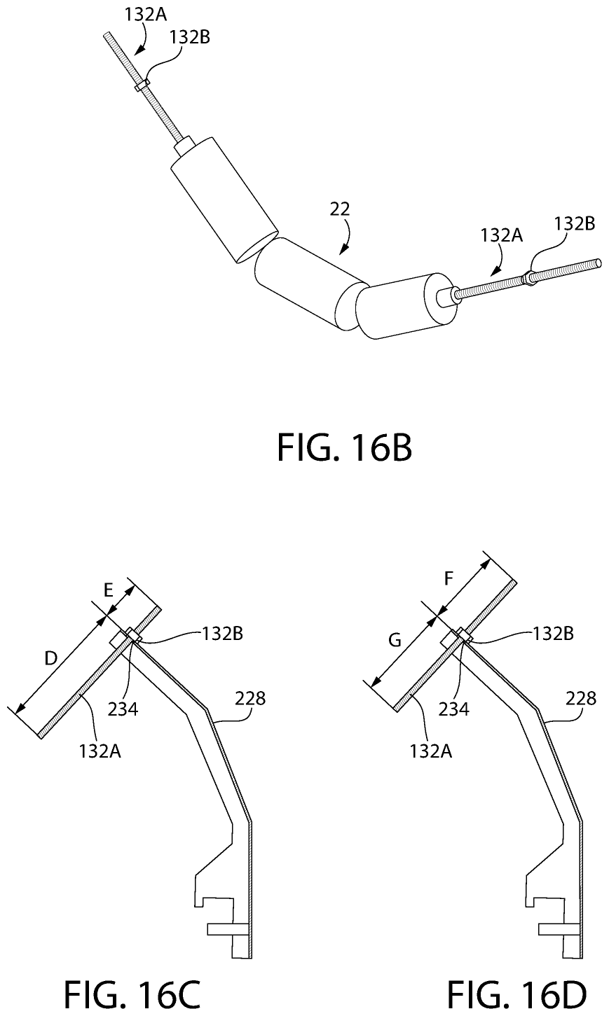

As shown most clearly in FIGS. 3 and 4A, the ACTCS 20 comprises a plurality of trough rollers 22, a plurality of return rollers 24, a stringer frame 26, adjustable troughing upright brackets (TB) 28, adjustable return roller brackets (RRB) 30 and couplings 32 (e.g., chains, cables, ropes, etc. (FIGS. 6-7) and alternative couplings (e.g., hooks 132, threaded element/nut 132A/132B, etc.) as shown in FIGS. 16-16D by way of example only. The ACTCS 20 is located at the curve CRVE (FIG. 2) of the tunnel T to maintain the conveyor belt CB centered on the plurality of trough rollers 22 and return rollers 24 as the belt CB moves through the turn or curve CRVE.

It should be understood that although three trough rollers 22 and two return rollers 24 are depicted in the figures, this is simply by way of example and the ACTCS 20 is not limited to those particular number of rollers. It should also be understood that the term “coupling 32” is meant to cover any device that allows the operator to adjust the length between the outer ends of the trough rollers 22/return rollers 24 and the corresponding sliding brackets TB 28/RRB 30; this covers, preferably, chains but also includes cables, ropes, etc. Other alternative couplings are also shown in FIGS. 16-16D.

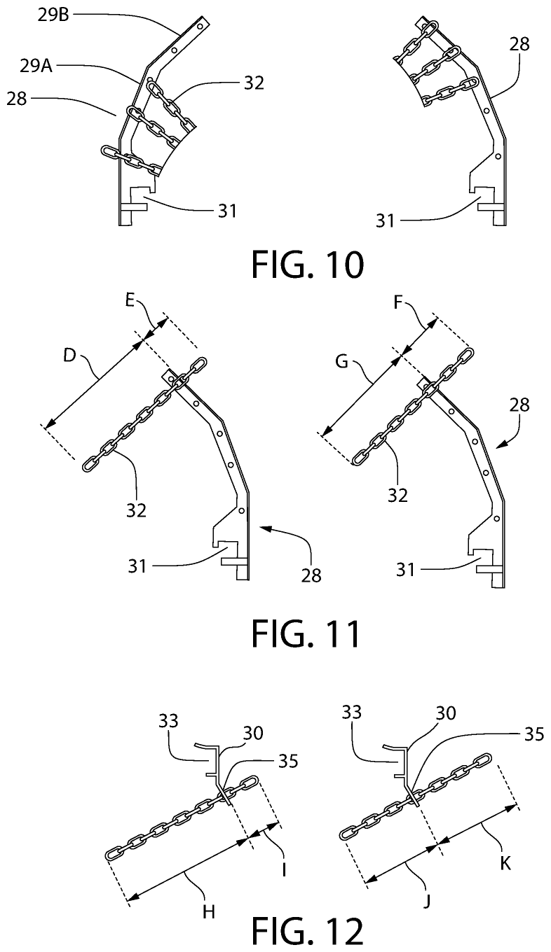

FIG. 4 depicts the stringer frame 26 which comprises a first pair of adjustable troughing upright brackets 28A and a second pair of adjustable troughing brackets 28B for adjusting the pitch and skew of a first set of trough rollers (see FIG. 4A) on one end of the stringer frame 26 and a second set of trough rollers (see FIG. 4A) on the other end of the stringer frame 26, respectively. The stringer frame 26 also comprises a single pair of return roller brackets 30A for adjusting the pitch and skew of the return rollers 24 (see FIG. 4A). The stringer frame 26 comprises stringer rails 26A and 26B which are connected together by cross braces 26C and 26D so that the rails 26A and 26B are parallel with respect to each other. Each TB 28 comprises a right-angled claw 31 (see FIGS. 10-11) and each RRB 30 comprises a C-shaped claw 33 (see FIG. 12) that allows them to freely slide along their respective stringer rails 26A or 26B. This ability to slide freely is important in allowing the trough rollers 22 and the return rollers 24 to skew. Thus, as shown most clearly in FIGS. 2 and 4A, the two sets of trough rollers 22 support the conveyor belt CB and payload MAT (see FIG. 2) at a first elevation with respect to the stringer frame 26 and the return rollers 24, located in between the two sets of trough rollers 22, support the return side (see FIG. 2) of the conveyor belt CB but at a lower elevation with respect to the stringer frame 26.

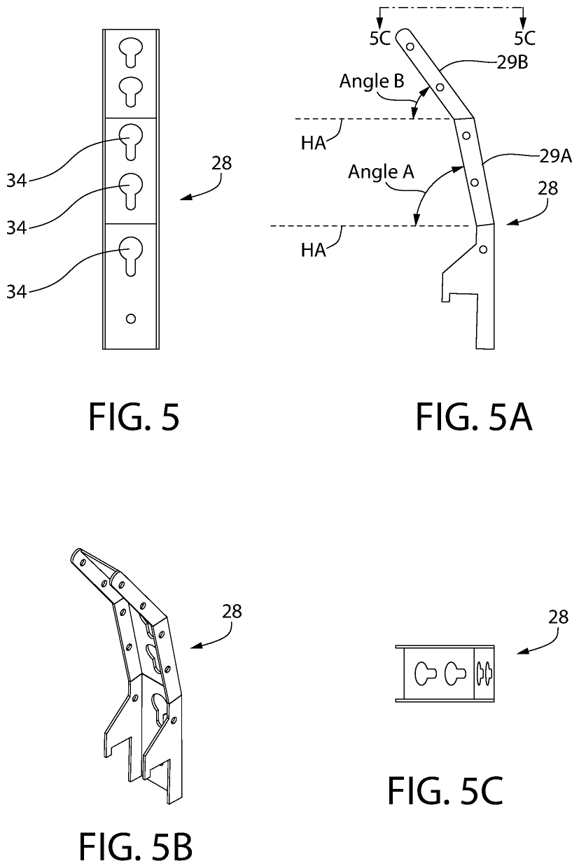

As can also be seen, each TB 28 comprises a plurality of apertures (e.g., “banjo holes”) 34 through which a coupling 32 (e.g. a chain, rope, etc.) can be releasably secured, as shown most clearly in FIGS. 10-11. Although five apertures 34 are shown (see FIG. 5), this is simply by way of example. Moreover, each TB 28 has angled portions 29A/29B (see FIGS. 5A and 10) to assist in establishing a particular pitch of the trough rollers 22. Thus, by way of example only, these angled portions 29A/29B each form a different angle (viz., Angle A and Angle B, respectively) with a horizontal axis HA (see FIG. 5A). As a result, with one end 32A of the coupling 32 releasably secured to the one end of a wing roller WB, and the other end or portion of the coupling 32 releasably secured in one of the apertures 34 of the TB 28, a particular pitch can be set for the trough rollers 22. It should be noted that there are two means of adjusting the pitch: (1) which aperture 34 in the TB 28 is selected and (2) the length of the coupling 32. In contrast, with regard to the return rollers 24, it should be noted that RRB 30 has only a single aperture 35 (FIGS. 4 and 12) since the length of the coupling 32 (FIG. 7) is the only parameter that needs to be changed to adjust the pitch of the return rollers 24. Thus, by way of example as shown in FIG. 10, the pitch of one set of trough rollers 22 can be set to different elevations, depending on which aperture 34 is selected in the pair of TB 28A/28B, on each end of the trough rollers 22. For example, one end of the trough rollers 22 can be raised (the right side of FIG. 10) by selecting a particular aperture in the right TB 28 while other end of the trough rollers 22 can be lowered by selecting a lower aperture 34 in the left TB 28. Furthermore, by changing the length of the coupler 32 on each side of the trough rollers 22, the pitch can be finely tuned, as shown in FIG. 11. Thus, using only one end of the trough rollers 22 by way of example only, having a first length D of the coupler 32, with a second length E of the coupler 32 extending beyond the TB 28 forms a first pitch on one end of the trough rollers 22, while forming a third length G of the coupler 32 with a fourth length F extending beyond the TB 28 forms a second pitch, different from the first pitch, on the same end of the trough rollers 22. As such, by changing the different length portions of the coupler 32, the operator can finely tune the pitch of the trough rollers 22, on both ends of the trough rollers 22.

To facilitate the change of trough rollers 22 or the return rollers 24, roller couplers 36 are provided that couple the rollers together, as well as permitting the first end 32A of the coupling 32 to be attached to the outer ends of the wing rollers WR, as shown most clearly in FIGS. 6-7.

The ACTCS 20 is installed in the tunnel T by suspending the stringer frame 26 in the tunnel T using mounting brackets 38 (only one of which is shown in FIGS. 3 and 8-9), mounted to a tunnel wall, on one side of the frame 26 while using another coupling 40 (e.g., a chain) on the other side of the stringer frame 26, as most clearly shown in FIGS. 3 and 4C. Each coupling 40 is coupled at one at one end to a connector 41 (FIG. 4C) on stringer rail 26B while the other end of the coupling 40 is releasably coupled to another bracket 42 mounted to a portion (e.g., ceiling) of the tunnel T.

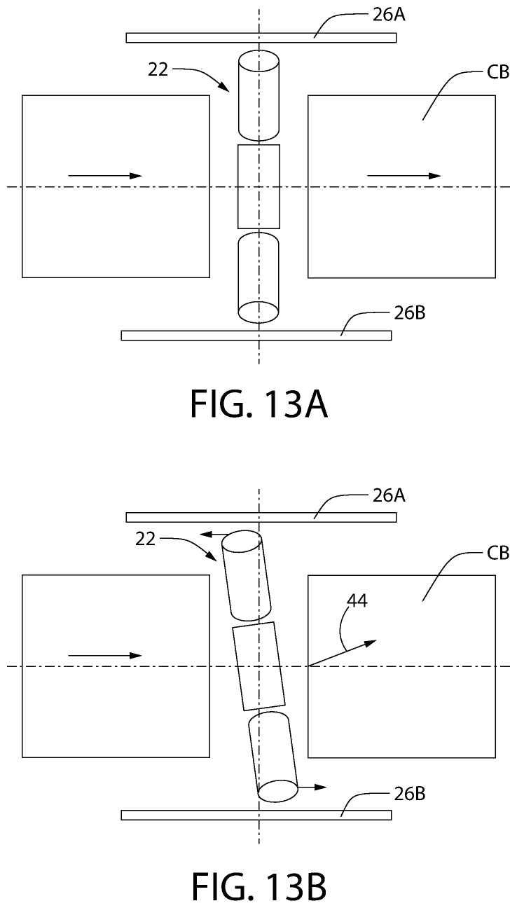

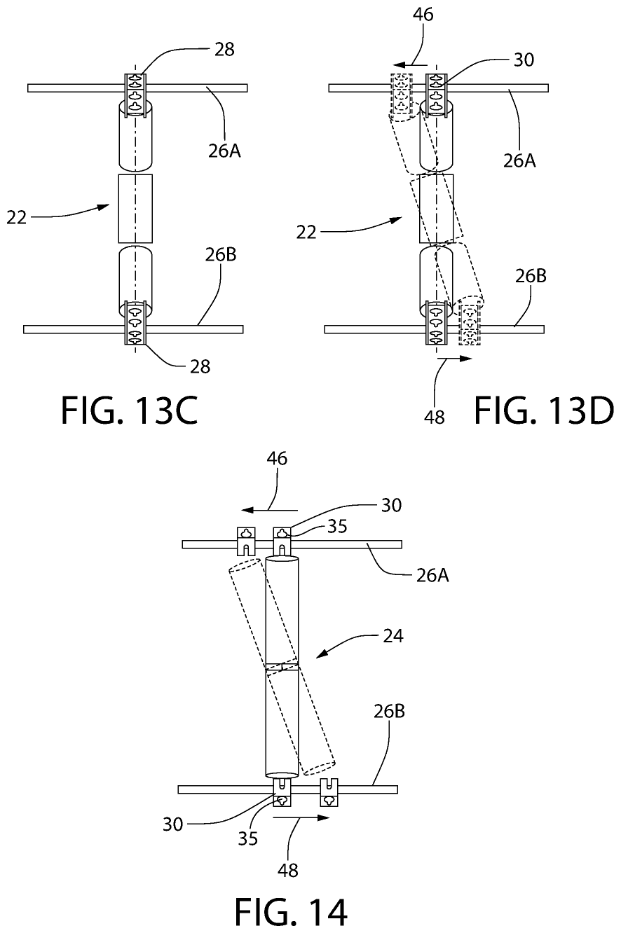

In view of the foregoing, the ACTCS 20 operates to implement the change of pitch and skew as follows in order to maintain the conveyor belt CB centered on the trough rollers 22/return rollers 24 as the conveyor belt CB passes through a turn/curve CRVE in the tunnel T. The operator selects the appropriate aperture 34 in each of the TBs 28, both front 28A and back 28B TB pairs using the couplings 32 to establish a particular pitch for the front and back trough roller sets 22 (FIG. 4A), and for the return rollers 24 using the RRBs 30. As the conveyor belt system is energized to move the conveyor belt CB, the skew is automatically adjusted, as shown in FIGS. 13A-14. In particular, when the conveyor belt CB is centered on the trough rollers 22 as shown in FIG. 13A, the TBs 28 remain stationary, as shown in FIG. 13C. However, if the belt tension changes in the direction of the arrow 44 (FIG. 13B) towards rail 26A, the TBs 28 on stringer rail 26A will slide in the direction of arrow 46 while the TBs 28 on stringer rail 26B will slide in the direction of arrow 48 to restore or center the conveyor belt CB on the trough rollers 22, as shown in FIG. 13D; correspondingly, the RRBs 30 will also slide accordingly, as shown in FIG. 14. Correspondingly, if the belt tension changes towards rail 26B, the TBs 28 and RRBs 30 would slide in the opposite directions as described above to again restore or center the conveyor belt CB on the trough rollers 22 and return rollers 24.

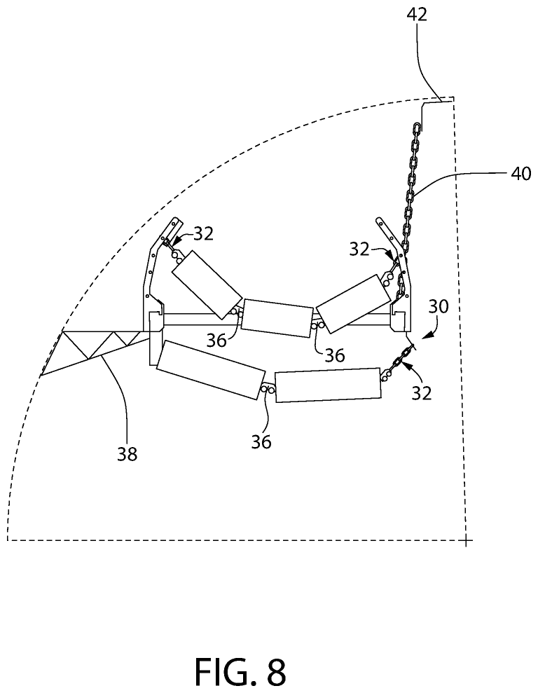

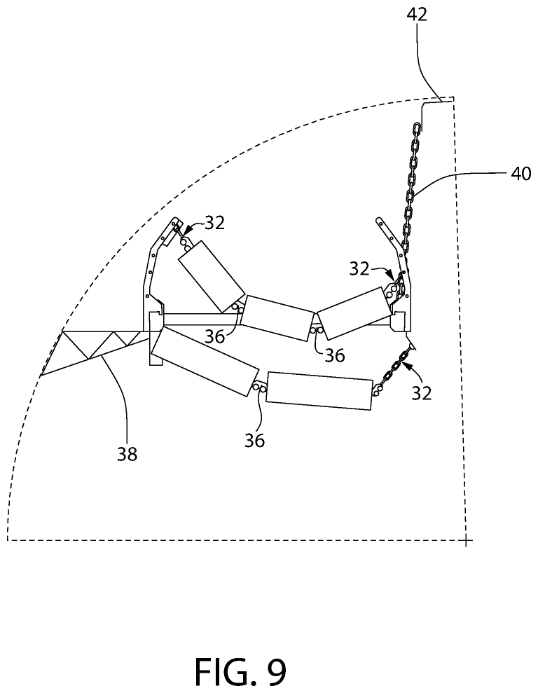

Should any adjustment still be needed to the pitch, the operator can easily adjust the couplings 32 on any one or more of the TBs 28 or RRWs 30. For example, a first pitch orientation is shown in FIG. 8. If that pitch is not corrective enough, the operator can adjust any one or more of the couplings 32 to a second pitch condition, such as the one shown in FIG. 9.

In view of the foregoing, it is within the broadest scope of the present invention that the ACTCS comprises only one set of trough conveyor rollers, as shown in FIGS. 15-15A. In particular, the ACTCS 120A (FIG. 15) and the ACTCS 120B (FIG. 15A) each comprise only one set of the plurality of trough rollers 22 at one end of a shortened stringer frame 126 (i.e., the length of the rails 126A/126B are shortened as compared to the rails 26A/26B of the stringer rail 26 of the ACTCS 20) while the only other set of conveyor rollers are the return rollers 24 which are located at the other end of the shortened stringer frame 126 and at a lower elevation, as discussed previously with regard to the ACTCS 20. As can be seen in FIG. 15, the plurality of trough rollers 22 are located at the “forward end” (i.e., downstream of conveyor belt motion) of the shortened stringer frame 126 while in FIG. 15A, the plurality of trough rollers 22 are located at the “rear end” (i.e., upstream of conveyor belt motion) of the shortened stringer 126. Other than those differences, the ACTCS 120A and ACTCS 120B utilize all of the same brackets 28/30, couplings 32, couplings 36 between rollers 22/24 and operate in the same manner as discussed previously with the ACTCS 20. As a result, either of these ACTCSs, 120A and 120B, permit for a smaller footprint and complexity as compared to the ACTCS 20 in achieving the manual adjustment of the pitch of a conveyor belt CB and automatically restoring the drift of the conveyor belt CB around a turn/curve CRVE in a confined space, e.g., a tunnel T.

FIG. 16 shows an alternative coupling, namely, a hook 132 that can be used for coupling the plurality of trough rollers 22 to an adjustable troughing upright bracket 128 for use with this alternative hook coupling 132. Although the hooks 132 are fixed in length, the angle at which the ends of the outer trough rollers 22 are coupled to the brackets 128 can still be adjusted by selecting the desired rung 133 on the bracket 128.

FIG. 16B shows a further alternative coupling using a threaded element 132A (e.g., a rod) 132A and a nut 132B that can be used to adjust the pitch of the troughing rollers 22. In particular, another adjustable troughing upright bracket 228 is provided for use with the threaded rod 132A and nut 132B. Apertures 234 (only one of which is shown in FIGS. 16C and 16D) provided in the upright bracket 228 (similar, but not necessarily identical, to the apertures 34 in the upright bracket 28, as discussed above) along the length of the bracket 228 allow the operator to select a plurality of angles to pass the threaded rod 132A through. Once the threaded rod 132A is passed through a desired aperture in the upright bracket 228 (as shown in FIGS. 16C and 16D), the operator can then finely tune the pitch adjustment by tightening the nut 132B against the upright bracket 228, to achieve the desired pitch, by adjusting the lengths, as indicated by D and E (FIG. 16C) and by F and G (FIG. 16D).

Furthermore, it should be understood that although FIGS. 16-16D depict the alternative couplings 132, 132A and 132B being used with the conveyor trough support rollers 22, these same alternative couplings can also be used with the return rollers 24, as shown and discussed in the previous embodiments with regard to the couplings 32.

While the invention has been described in detail and with reference to specific examples thereof, it will be apparent to one skilled in the art that various changes and modifications can be made therein without departing from the spirit and scope thereof.

What is claimed is:

1. An apparatus for manually adjusting the pitch of a conveyor belt, both a delivery portion having a payload thereon and a return portion after the payload has been removed, and automatically restoring the drift of a conveyor belt around a turn in a confined space, said apparatus comprising:
a pair of rails between which a first set of conveyor belt rollers are slidably coupled, said first set of conveyor belt rollers being positioned at a first end of said pair of rails at a first elevation above said pair of rails for supporting the delivery portion of said conveyor belt;
a second set of conveyor belt rollers slideably coupled between said pair of rails and wherein said second set of conveyor belt rollers are positioned below said pair of rails at a lower elevation than said first elevation for supporting the return portion of the conveyor belt;
a first pair of brackets that can slide on respective rails and to which respective ends of said first set of conveyor belt rollers can be adjustably coupled thereto; and
a second pair of brackets that can slide on respective rails and to which respective ends of said second set of conveyor belt rollers can be adjustably coupled thereto.

2. The apparatus of claim 1 wherein each of said respective ends of said first and said second conveyor belt rollers can be releasably coupled to said one of said first and said second pair of brackets using a respective coupling whose length can be easily changed by an operator.

3. The apparatus of claim 1 wherein said each one of said first pair of brackets comprises an upper portion having a plurality of apertures for releasably connecting said coupling thereto.

4. The apparatus of claim 3 wherein said upper portion comprises a plurality of segments that each form a different angle with respect to a horizontal axis.

5. The apparatus of claim 4 wherein said coupling is a chain.

6. The apparatus of claim 4 wherein said coupling comprises a threaded element and a corresponding nut.

7. The apparatus of claim 1 wherein said each one of said first pair of brackets comprises an upper portion having a plurality of rungs for releasably connecting said coupling thereto.

8. The apparatus of claim 7 wherein said upper portion comprises a plurality of segments that each form a different angle with respect to a horizontal axis.

9. The apparatus of claim 8 wherein said coupling is a hook.

10. The apparatus of claim 1 wherein said first set of conveyor belt rollers comprise a trough configuration whereby a central roller has an angled wing roller coupled on each side of said central roller.

11. The apparatus of claim 1 further comprising:
a third set of conveyor belt rollers slidably coupled between said pair of rails, said third set of conveyor belt rollers being positioned at a second end, opposite said first end, of said pair of rails and at said first elevation above said pair of rails for supporting the delivery portion of the conveyor belt;
a third pair of brackets that can slide on respective rails of said pair of rails and to which respective ends of said third set of conveyor belt rollers can be adjustably coupled; and
wherein said second set of conveyor rollers being positioned between said first and said third set of conveyor belt rollers.

12. The apparatus of claim 11 wherein each of said respective ends of said third conveyor belt rollers can be releasably coupled to said one of said third pair of brackets using a respective coupling whose length can be easily changed by an operator.

13. The apparatus of claim 12 wherein said each one of said third pair of brackets comprises an upper portion having a plurality of apertures for releasably connecting said coupling thereto.

14. The apparatus of claim 13 wherein said upper portion comprises a plurality of segments that each form a different angle with respect to a horizontal axis.

15. The apparatus of claim 14 wherein said coupling is a chain.

16. The apparatus of claim 14 wherein said coupling comprises a threaded element and a corresponding nut.

17. The apparatus of claim 11 wherein said each one of said third pair of brackets comprises an upper portion having a plurality of rungs for releasably connecting said coupling thereto.

18. The apparatus of claim 17 wherein said upper portion comprises a plurality of segments that each form a different angle with respect to a horizontal axis.

19. The apparatus of claim 18 wherein said coupling is a hook.

20. The apparatus of claim 11 wherein said first set of conveyor belt rollers and said third set of conveyor belt rollers each comprise a trough configuration whereby a central roller has an angled wing roller coupled on each side of said central roller.

21. A method for manually adjusting the pitch of a conveyor belt, having a delivery portion with a payload thereon and a return portion after the payload has been removed, and automatically restoring the drift of a conveyor belt around a turn in a confined space, said method comprising:
providing a pair of rails between which a first set of conveyor belt rollers are slidably coupled, said first set of conveyor belt rollers being positioned at a first end of said pair of rails at a first elevation above said pair of rails for supporting the delivery portion of the conveyor belt;
providing a second set of conveyor belt rollers slideably coupled between said pair of rails and wherein said second set of conveyor belt rollers are positioned below said pair of rails at a lower elevation that said first elevation for supporting the return portion of the conveyor belt;
adjustably coupling respective ends of said first set of conveyor rollers to a first pair of brackets that can slide on respective rails;
adjustably coupling respective ends of said second set of conveyor rollers to a second pair of brackets that can slide on respective rails; and
suspending said pair of rails in the confined space at the curve.

22. The method of claim 21 wherein steps of adjustably coupling respective ends of said first set of conveyor rollers and of said second set of conveyor rollers comprises using a respective coupling whose length can be easily changed by an operator in coupling each of said respective ends of said first and said second conveyor belt rollers to said one of said first and second pair of brackets, respectively.

23. The method of claim 21 wherein said step of adjustably coupling respective ends comprises providing each one of said first pair of brackets with an upper portion having a plurality of apertures for releasably connecting said respective coupling thereto.

24. The method of claim 23 wherein said step of providing each one of said first pair brackets with said upper portion comprises forming said upper portion with a plurality of segments that each form a different angle with respect to a horizontal axis.

25. The method of claim 24 wherein said coupling is a chain.

26. The method of claim 24 wherein said coupling is a threaded element and a corresponding nut.

27. The method of claim 21 wherein said step of adjustably coupling respective ends comprises providing each one of said first pair of brackets with an upper portion having a plurality of rungs for releasably connecting said respective coupling thereto.

28. The method of claim 27 wherein said step of providing each one of said first pair brackets with said upper portion comprises forming said upper portion with a plurality of segments that each form a different angle with respect to a horizontal axis.

29. The method of claim 28 wherein said coupling is a hook.

30. The method of claim 21 wherein said step of providing said pair of rails between which said first set of conveyor belt rollers are slidably coupled comprises providing a trough configuration whereby a central roller has an angled wing roller coupled on each side of said central roller.

31. The method of claim 21 further comprises the steps of:
providing a third set of conveyor belt rollers slidably coupled between said pair of rails and positioning said third set of conveyor rollers at a second end, opposite said first end, of said pair of rails at said first elevation above said pair of rails for supporting the delivery portion of the conveyor belt; and
adjustably coupling respective ends of said third set of conveyor rollers to a third pair of brackets that can slide on respective rails and wherein said second set of conveyor rollers is positioned between said first and said third set of conveyor belt rollers.

32. The method of claim 31 wherein step of adjustably coupling respective ends of said third set of conveyor rollers comprises using a respective coupling whose length can be easily changed by an operator in coupling each of said respective ends of said first, said second and said third conveyor belt rollers to said one of said first and second pair of brackets, respectively.

33. The method of claim 31 wherein said step of adjustably coupling respective ends of said third set of conveyor rollers comprises providing each one of said third pair of brackets with an upper portion having a plurality of apertures for releasably connecting said coupling thereto.

34. The method of claim 33 wherein said step of providing each one of said third pair brackets with said upper portion comprises forming said upper portion with a plurality of segments that each form a different angle with respect to a horizontal axis.

35. The method of claim 34 wherein said coupling is a chain.

36. The method of claim 34 wherein said coupling is a threaded element and a corresponding nut.

37. The method of claim 31 wherein said step of adjustably coupling respective ends comprises providing each one of said third pair of brackets with an upper portion having a plurality of rungs for releasably connecting said respective coupling thereto.

38. The method of claim 37 wherein said step of providing each one of said third pair brackets with said upper portion comprises forming said upper portion with a plurality of segments that each form a different angle with respect to a horizontal axis.

39. The method of claim 38 wherein said coupling is a hook.

40. The method of claim 31 wherein said steps of providing said pair of rails between which said first set of conveyor belt rollers are slidably coupled and between which said third set of conveyor belt rollers are slidably coupled each comprise providing a trough configuration whereby a central roller has an angled wing roller coupled on each side of said central roller.
